(19) United States
(12) Patent Application Publication
(10) Pub. No.: US 2014/0040018 A1
(43) Pub. Date: Feb. 6, 2014

(54) Systems, Methods, and Apparatuses for Advertising Generation, Selection and Distribution System Registration

(71) Applicant: MONSTER WORLDWIDE, INC., New York, NY (US)

(72) Inventor: Danielle F. Dellovo, North Andover, MA (US)

(21) Appl. No.: 13/931,487

(22) Filed: Jun. 28, 2013

Related U.S. Application Data
(63) Continuation of application No. 11/748,470, filed on May 14, 2007.
(60) Provisional application No. 60/747,176, filed on May 12, 2006.
(60) Provisional application No. 60/747,405, filed on May 16, 2006.
(60) Provisional application No. 60/824,888, filed on Sep. 7, 2006.

(51) Int. Cl. G06Q 30/02

(52) U.S. Cl. CPC G06Q 30/0251; G06Q 30/0246
USPC 705/14.45

(57) ABSTRACT

The present invention discloses apparatuses, systems and methods for providing the generation, serving and distribution of advertisements. Specifically, the disclosed system is particularly suited tor the efficient generation and distribution of ads representing narrow offers that are typically advertised using classified ads. The invention allows classified ad to be turned into web advertisements. In addition, affiliated content web sites gather and record information about the visitors to their sites. This information is used to display relevant ads to the web site visitors.

### RELATED APPLICATIONS

This disclosure claims priority to under 35 U.S.C. §119 and incorporates by reference U.S. Provisional Patent Applications Ser. No. 60/747,176, titled “Job Advertising Generation and Network for Distributing the Same,” filed May 12, 2006, Ser. No. 60/747,405, titled “Job Distribution Network,” filed May 16, 2006, and Ser. No. 60/824,888, titled “System and Method for Advertisement Generation, Selection and Distribution,” filed Sep. 7, 2006. The disclosure also incorporates pending, related non-provisional applications titled “Systems, Methods and Apparatuses for Advertisement Generation,” filed May 14, 2007, as Serial No. ______; “Systems, Methods, and Apparatuses for Advertisement Targeting/Distribution,” filed May 14, 2007 as Serial No. _______; and “Systems, Methods and Apparatuses for Advertisement Evolution,” filed May, 14, 2007, Serial No. ______, which are all incorporated herein by reference.

### FIELD OF THE INVENTION

The present invention is generally directed to apparatuses, methods and systems for managing advertising. More specifically, the present invention is related to apparatuses, systems and methods for the generation, selection and distribution of online advertising.

### BACKGROUND OF THE INVENTION

Advertisements offering goods, services, or opportunities can generally be split into two groups depending on whether the offers are narrow or broad. Broad offers that are applicable to a relatively large number of recipients, generally utilize print, radio, television and online advertising techniques that push the advertisement out to a large audience.

On the other hand, narrow offers that are limited in scope, either because they are only relevant to a small target audience or because there are only a few offers available, tend to use advertising mechanisms that rely on the audience finding the advertisement. Classified ads are one example of this limited class of offers. The classifieds rely on readers to search through the ads and look for offers that might be relevant to them. The need for the audience to seek out relevant offers is not ideal.

### SUMMARY OF THE INVENTION

In view of the foregoing, the present invention provides systems, methods and apparatuses for the generation, management and distribution of advertisements. More specifically, embodiments of the system are particularly suited for the efficient generation and broad distribution of ads representing narrow listing offers.

In accordance with one aspect of the present invention systems, methods and apparatus are disclosed for creating advertisements from narrow listing offers. The process involves retrieving a structured listing (base data entry) proposing an offer containing listing criteria comprising a title, a category, offer terms and a description. The listing is parsed to extract one or more listing criteria. One or more of the parsed listing criteria are selected for inclusion in an advertisement. An advertisement derived from the selected listing criteria is then generated and distributed.

In accordance with another aspect of the present invention, systems, methods and apparatuses are disclosed for optimizing online advertisements. A plurality of different online advertisements directed to a particular offer are generated and displayed such that a mechanism is provided for viewers to indicate their interest in the offer presented in the advertisement. In some implementations, viewer interest may be determined based on a viewer's interaction characteristics with a distributed advertisement. Each of the plurality of different online advertisements are displayed to a plurality of viewers. For each of the different online advertisements displayed, the number of indications of viewer interest are recorded. The number of indications of viewer interest for each of the different online advertisements are then compared. The online advertisements having relatively more indications of viewer interest are selected for further distribution and display.

In accordance with a further aspect of the present invention, systems, methods and apparatuses are disclosed for optimizing online advertisement generators. A plurality of different online advertisement generators are used to generate a plurality of online advertisements from one or more underlying structured listing. The online advertisements are displayed to a plurality of viewers and viewer interest is determined. In an implementation, viewers are provided with a to indicate their interest in the offer presented by the online advertisement. The number of indications of viewer interest are recorded for each of the different online advertisement generators. The indications of viewer interest are compared for each the different online advertisement generators. One or more of the different online advertisement generators are selected for further use because they have relatively more indications of view interest.

In accordance with a further aspect of the present invention, systems, methods and apparatuses are disclosed for optimizing online advertisements. A plurality of different online advertisements directed to a particular offer are generated. Each of the plurality of different online advertisements are displayed to a plurality of viewers, wherein one or more characteristics are known about each of the viewers. For each of the different online advertisements displayed, the number times viewers indicate their interest in the advertisement are recorded. The recorded indications of viewer interest are associated with the one or more characteristics known about the viewer that provided the indication of viewer interest. For at least one characteristic, the number of indications of viewer interest recorded is correlated to the online advertisements shown to viewers having that characteristic. One or more of the different online advertisements having relatively more indications of view interest are selected for further viewing.

In accordance with a further aspect of the present invention, systems, methods and apparatuses are disclosed for optimizing online advertisements. A plurality of different online advertisement generators are used to generate a plurality of different online advertisements. The generated advertisements are displayed to a plurality of viewers, wherein one or more characteristics are known about each of the viewers. For each of the different online advertisement generators, the indications of viewer interest in the online advertisements generated by the particular online advertisement generator are recorded. One or more characteristics known about the viewer that provided the indication of viewer interest are recorded and associated with the indications of viewer interest. For at least one characteristic, the number of indications of viewer interest recorded supporting the advertisements generated the different online advertisement generators are correlated to viewers having that characteristic. One or more of the different online advertisement generators having relatively more indications of view interest are selected for further generation of ads to be displayed to viewers with the correlated characteristics.

In accordance with a further aspect of the present invention, systems, methods and apparatuses are disclosed for displaying targeted job advertisements to prospective candidates. An online test is provided to determine one or more characteristics about the test taker based on the test taker's answers. Available job advertisements are searched for compatibility with the test taker's characteristics. One or more job advertisement matching the test taker's characteristics are displayed to the test taker.

In accordance with a further aspect of the present invention, systems, methods and apparatuses are disclosed for generating targeted advertisements for viewers. One or more characteristics about a current web site viewer are received. A listing database is searched for listings compatible with the one or more received viewer characteristics. An advertisement is generated from the one or more listings discovered in the search. The generated advertisement is displayed to the web site viewer.

In accordance with a further aspect of the present invention, systems, methods and apparatuses are disclosed for displaying targeted job advertisements to prospective candidates. One or more viewer characteristics associated with current web viewer are received. Also, characteristics associated with a content provider/affiliate who is displaying content to the current web viewer may also be received. A listing database is searched for listings compatible with the one or more received viewer characteristics and/or content provider characteristics. An advertisement may be generated and distributed based on a selected listing.

In an implementation, available job advertisements are searched for characteristics matching the viewer's recorded characteristics. Each job advertisement has an associated ad purchase criteria that specifies the ad cost relative to number of viewer criteria matched. The job advertisements with the a relatively higher associated ad cost are displayed to the current web viewer.

### BRIEF DESCRIPTION OF THE DRAWINGS

The accompanying appendices and/or drawings illustrate various non-limiting, representative, inventive aspects in accordance with the present disclosure:

FIG. 1 is a diagram illustrating the entities that interact with the system according to an embodiment of the invention.

FIGS. 2A-2B are flow diagrams illustrating aspects of the interaction between a system user and the system according to an embodiment of the invention.

FIG. 3A-3B illustrate aspects of a system user ad management tool, according to an embodiment of the invention.

FIG. 4A illustrates aspects of a base data entry, according to an embodiment of the invention.

FIG. 4B illustrates aspects of the base data entry conversion process for creating an advertisement, according to an embodiment of the invention.

FIG. 5 illustrates aspects of examples advertisement generated by the system, according to an embodiment of the invention.

FIG. 6 illustrates aspects of ad evolution, according to an embodiment of the invention.

FIG. 7 illustrates aspects of ad generation and distribution, according to an embodiment of the invention.

FIG. 8 illustrates aspects of advertisement generation and distribution according to an embodiment of the invention.

FIG. 9 illustrates aspects of a system database module.

FIG. 10 illustrates an ad distribution module, according to an embodiment of the invention.

FIG. 11 illustrates another ad distribution module, according to an embodiment of the invention.

FIG. 12 illustrate aspects of advertisement performance analysis according to an embodiment of the invention.

FIG. 13A-13C illustrate various configurations of the system according to an embodiment of the invention.

FIG. 14 illustrates aspects of an embodiment of a CAN controller in accordance with an embodiment of the disclosed system.

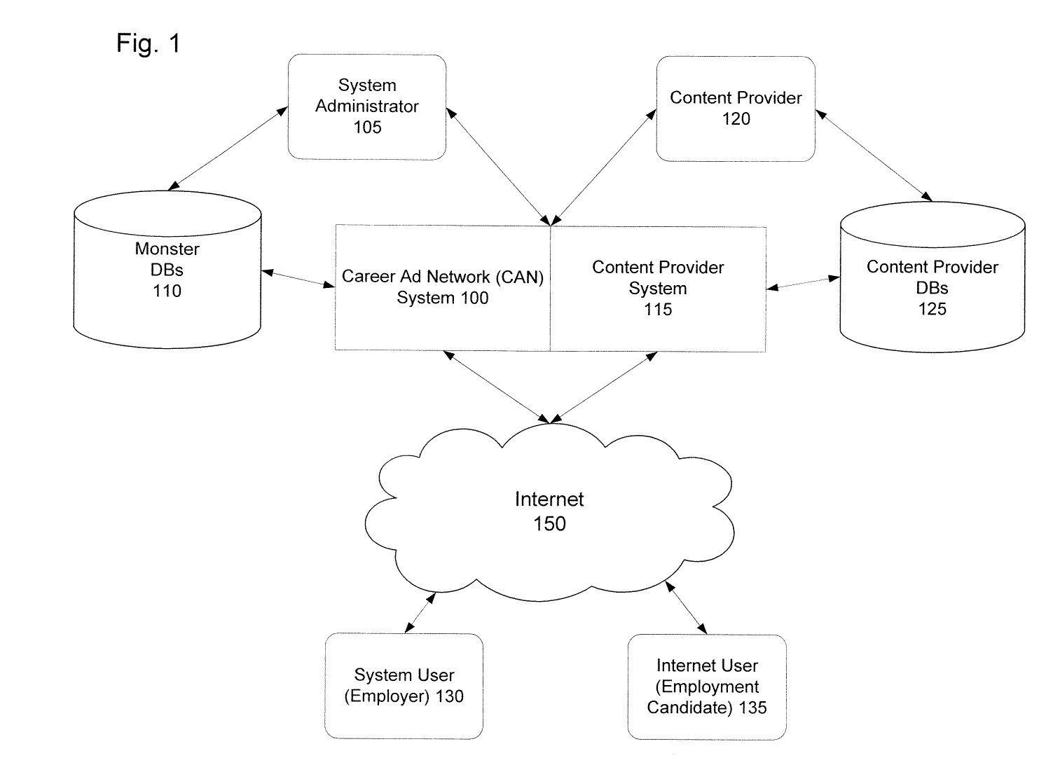

The leading number of each reference numeral indicates the first drawing in which that reference numeral is introduced. For example, content provider database (DB) 125 is first introduced in FIG. 1.

### DETAILED DESCRIPTION

The present disclosure includes a discussion of systems, methods, and apparatuses for generating, managing and distributing advertisements. The disclosed system is particularly suited for use with a system user's (sponsor's) one or more or narrow listing offers (base data entries), where traditional passive advertising would be ineffective. The disclosed examples are discussed in the context of job placement advertisements, which may be considered as narrow listing offers because they generally are only relevant to a small audience of qualified applicants. Furthermore, job placement advertisements are usually directed to attracting applicants for a limited pool of available positions. It is to be understood that while the system is described in the context of job placement advertisements, the system provides an administrator with significant flexibility and freedom to configure the system for any other number of narrow listing offer or advertisement applications, such as classified product listings including automobiles, personals, real estate, etc.

### Overview

FIG. 1 provides an overview of various entities that may interact with the system at various points during system utilization. According to an embodiment of the invention, the Career Advertisement Network (“CAN”) 100 is a central element in the system facilitating the functionality described herein. A system user (e.g., an employer) 130 connects with the CAN 100 over the internet 150. The system user may either create a new advertising campaign or manage an existing advertising campaign. According to an embodiment, the advertisements created and distributed by the CAN 100 are based on corresponding narrow listings, configured in this example as job opportunity listings stored within a job listing web site's job listing database (e.g., Monster DB) 110.

The system user 130 uses the CAN 100 to create advertisements based on selected job listings (based data entries) stored within the job listing DB 110. Advantageously, the CAN 100 incorporates a flexible system user interface, wherein a system user (e.g., employer or sponsor)130 may determine how much interaction/input they wish to have in the advertisement creation process. Depending on the needs of a particular user, most of functionality associated with the CAN 100 can be implemented based on system-driven processes. Alternately, some system functionality may be may configured so that a system user 130 can work with a system administrator 105 to create/manage an advertisement campaign.

As illustrated in FIG. 1, the CAN 100 coordinates creating and distributing advertisements with content provider system 115. In an embodiment, the content provider system 115 creates and distributes online content from the content provider databases 125 or other sources. The CAN system creates and distributes advertisements that are incorporated into the content as it is presented to an internet user 135. Generally, the content provider may be configured as a web site that provides an internet user 135 with online content such as news, entertainment, sports, online media or other types of online content. Furthermore, depending on the actual implementation, the content provider may be an affiliate web site, a partner web site or even hired as an advertisement placement provider.

For example, the content provider 120 may be configured as a sports news web site. The content provider 120 distributes various sports news content from the content providers database 125. The CAN 100 may be configured to coordinate incorporating CAN generated advertisements into the content distributed by the content provider's system 115. The CAN 100 is configured to create the advertisement based on a variety of factors, some of which may include: a content provider's content, a content provider's advertisement system configuration, web user 135 characteristics, and/or any variety of other distribution metrics established by the system user 130 or system administrator 105. In some embodiments, the CAN 100 may be configured with an advertisement tracking module configured to track and record data associated with a web user's interaction with the displayed advertisement.

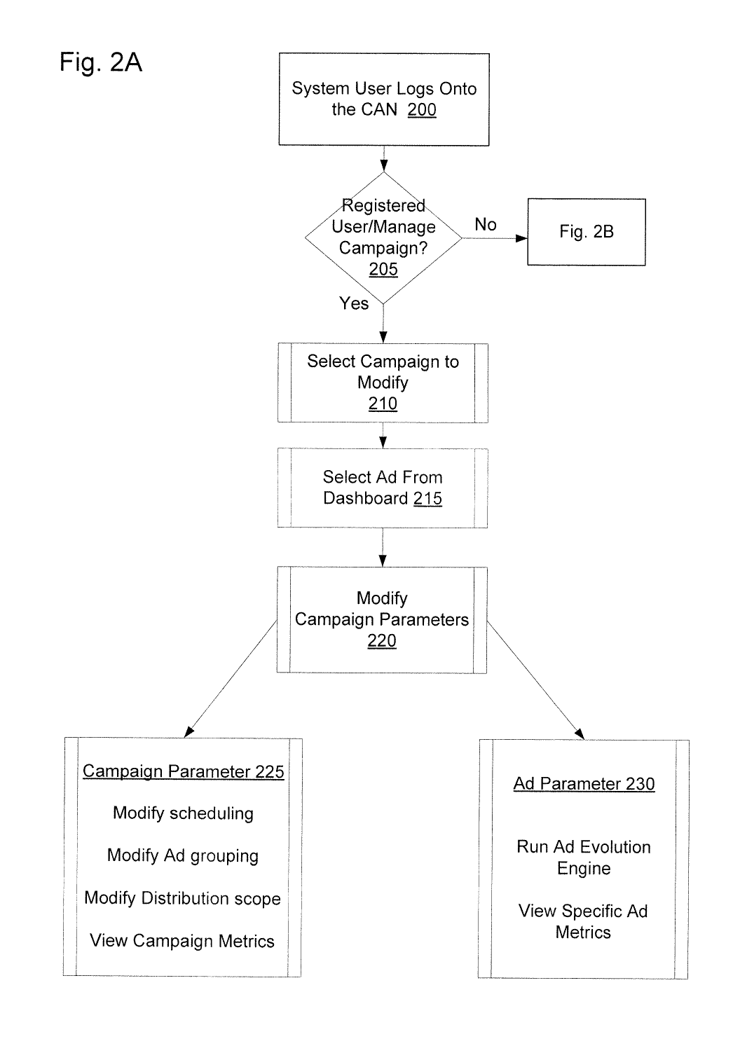

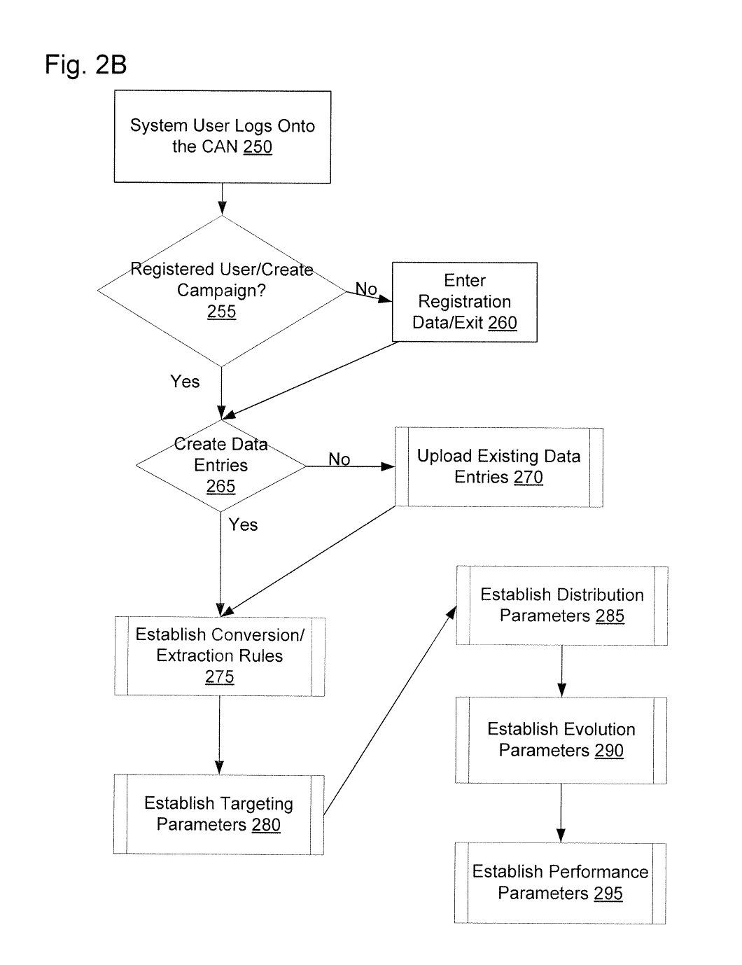

FIGS. 2A-2B are high-level flow diagrams illustrating a system user campaign management functionality associated with the system: campaign creation and campaign management. The system user attempts to log onto the CAN in step 200. If the user is not a registered user, the system user must go through a registration process. However, at this point (step 205) the system branches between campaign management (210-230) and campaign creation (in FIG. 2B).

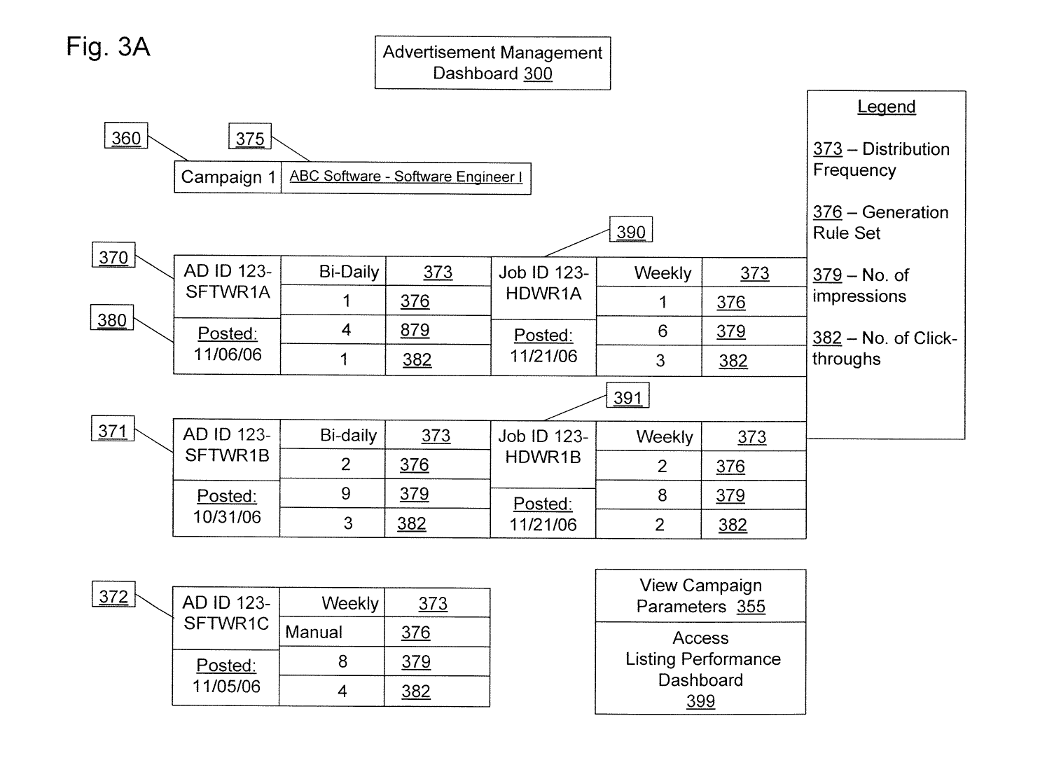

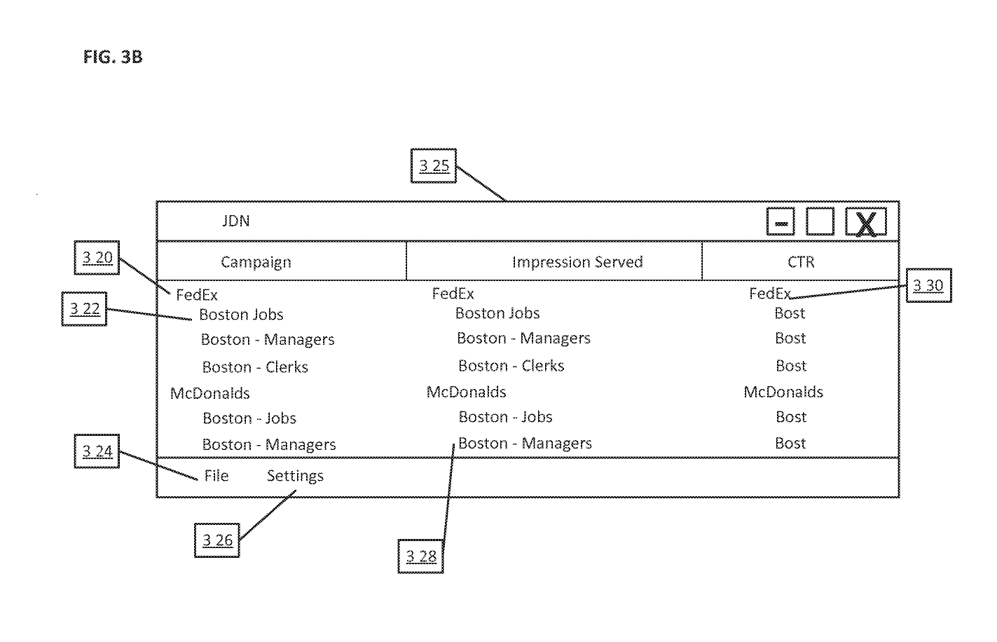

If the system user selects the campaign creation branch in step 205, the system user moves into a campaign selection module 210. In one embodiment, after the system user's campaign has been selected, the system user can then choose an ad from a management dashboard (shown in FIG. 3A) in step 215. In an alternate embodiment, the system maintains a CAN widget (shown in FIG. 3B) instead of the management dashboard. Step 220 involves modifying the parameters of the campaign in step 230 or the advertisements that make up a campaign in step 230. By way example only, the system user can modify campaign scheduling parameters, add or drop advertisements from a campaign, modify the advertisement distribution scope; or view campaign performance metrics. Furthermore, the system user can modify single advertisement parameters, designate a particular advertisement for evolution engine optimization or view specific advertisement performance metrics.

FIG. 2B illustrates aspects of the system user campaign creation process. The system user logs onto the system in step 250 and enters the campaign creation module in step 255. The system user registers with the system and then is directed to the create new data entry module in step 265. The system is configured so that the system user can upload existing data entries to the system in step 270. Alternately, the system user may interact with a listing creation module to create data entries for incorporating into a campaign. Once the system user designates the particular data entries for conversion to advertisements, the system user works with the CAN system to step through the ad creation and distribution process (275-295). More specifically, the system user establishes conversion/extraction rules in step 275 that the system users to extract the key terms from a base data entry. The key terms are then used to populate an empty advertisement template.

In step 280, the system user selects either basic or premium targeting parameters. The system identifies advertisement distribution opportunities based on a limited data pool. In contrast, if the user establishes premium targeting parameters, the system uses an expansive data pool to determine when to incorporate an advertisement into distributed content. The expansive data pool may be derived from a web user's surfing characteristics obtained through the system or system partners/affiliates. After establishing the targeting parameters, the system user establishes distribution parameters in step 285. The distribution parameters are user driven parameters, (e.g., a user can determine the distribution scope for an advertisement—whether the advertisement should be incorporated with news content, multiple sports news sites content or a single sports news site's content, or a single sports news site's football content, etc . . . ). In some embodiments of the invention, the user establishes advertisement evolution parameters in step 290 and performance metrics in step 295.

FIGS. 3A and 3B illustrate an campaign management dashboard and a campaign management widget, respectively. In FIG. 3A, the management dashboard 300 can be configured to display distribution parameters, performance metrics and/or a variety of other parameters associated with a particular campaign 360. In FIG. 1, the dashboard is configured to display advertisement parameters including the distribution frequency 373, the advertisement generation rule set user to create the advertisement 376, the number of impressions 379 or the number of click-throughs 382 associated with a particular advertisement 370, 371, 372, 390, 391. Advantageously, through the management dashboard, the system user can easily evaluate the performance/generation/distribution metrics associated with an advertisement. In some implementations, the dashboard may be configured to display campaign overview parameters 355 (e.g. the total number of qualified resumes that can be correlated to the advertisements within a campaign, the setting campaign specific distribution parameters, etc . . . ). Also, in some embodiments the dashboard may be configured to display the advertisement in a popup window when the system user mouses over the advertisement identifier. In FIG. 3B, the advertisement management widget 325 is illustrated displaying campaign-level parameters (including sponsor name 320 and campaign name 322). However, it is to be understood that the widget can also be configured with display functionality similar to that described above with regard to the management dashboard. The system user may change the displayed parameters/metrics on the widget by selecting the desired setting from the file menu 324 and/or the settings menu 326.

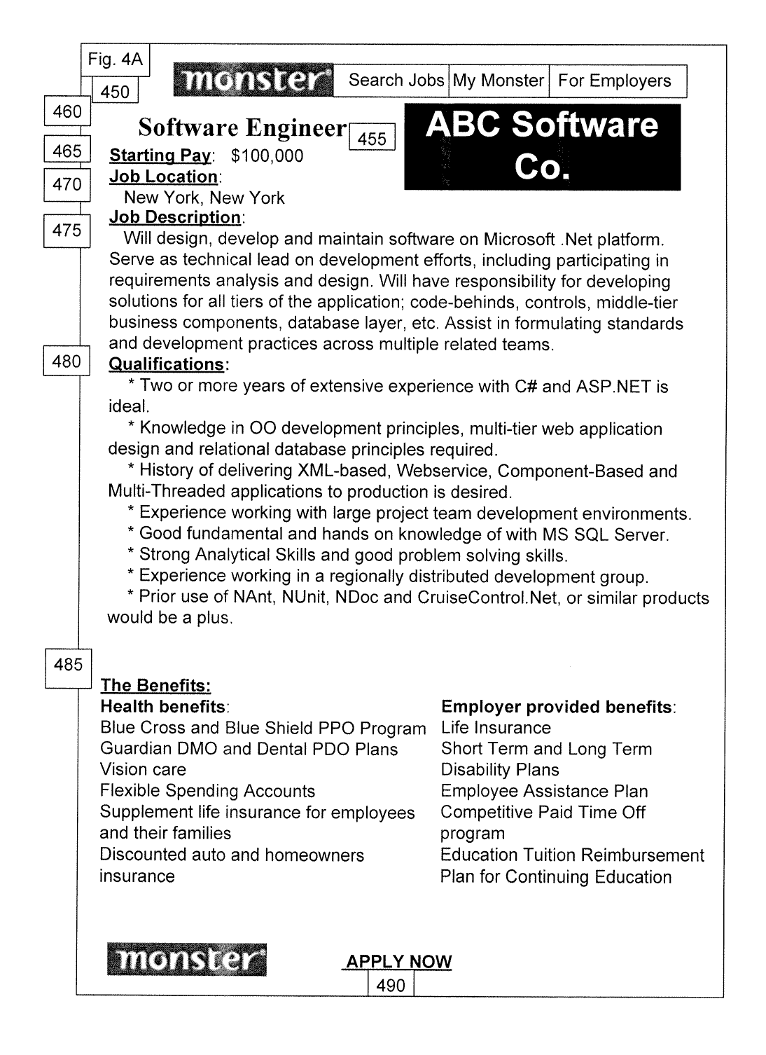

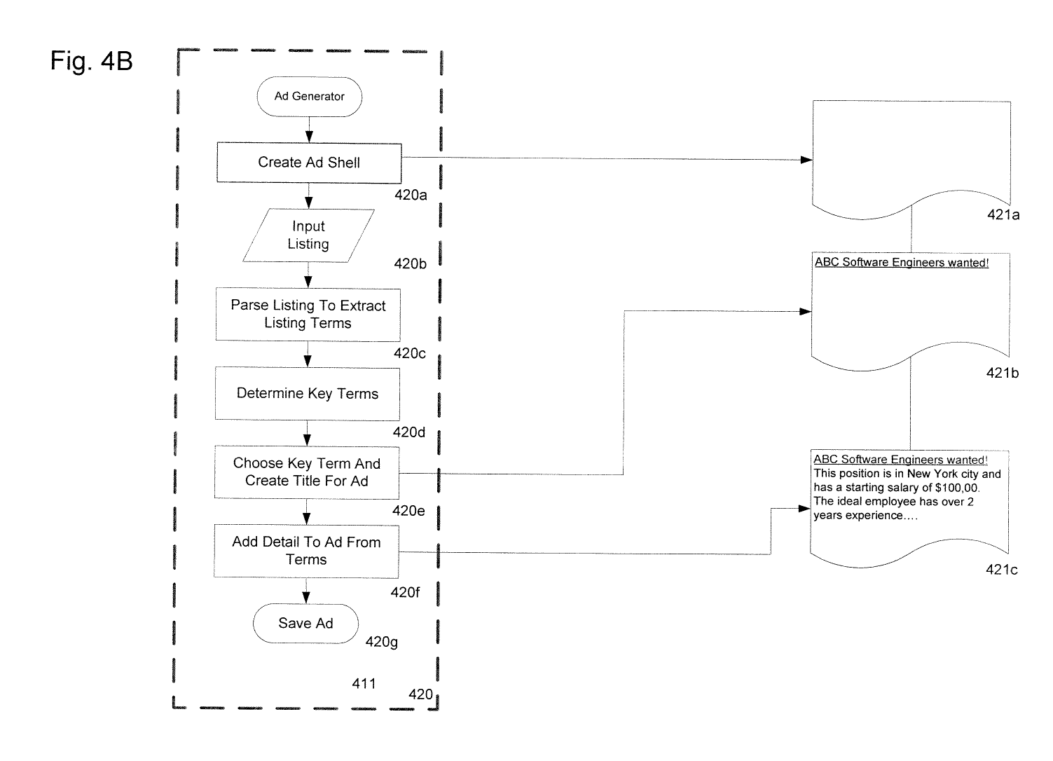

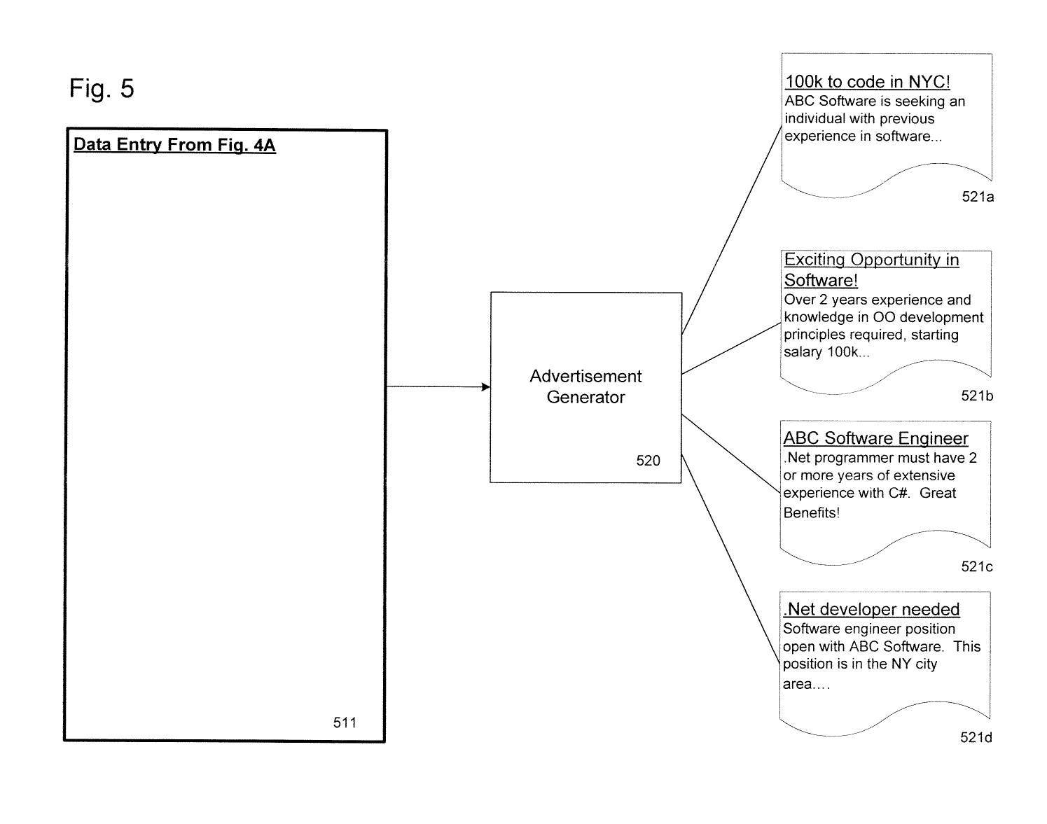

FIG. 4A is an example of a base data entry (narrow listing) directed to a software engineering job opportunity hosted by an employment opportunity host web site (e.g., Monster.com). By way of example only, the CAN may be configured to identify and extract certain key parameters from the full data entry during the advertisement generation process. It is to be understood that the CAN may be configured to coordinate with a variety of data entry host web sites beyond the employment opportunity context. For example, the key term identification and extraction process may be keyed to a variety of shopping web sites, real estate listing web sites, and/or travel web sites. In the example illustrated in FIG. 4A, directed to an employment opportunity example, the CAN extracts key terms such as the name of the data entry sponsor 455. Alternately, depending on the characteristics of an employment opportunity, the key terms may be based on parameters such as: opportunity title 460, offered salary 465, geographic location, 470, job description 475, required qualifications 480, and/or key benefits 485. Depending on the established generation rule set, different combinations of key terms may be used to generate the advertisement.

Ad Generation

FIG. 4B shows an exemplary process 420, which would be performed by the MEN, for generating an ad 421 from a job listing 450. The first step 420a of the ad generation process begins with the creation of an ad shell 421a. Next in step 420b, the job listing 450 is input to the process. The job listing is then parsed to extract the job listing terms 420c. In the parsing step, an advertisement generator module categorizes and tags the information extracted from the job listing. For example, the listing may be parsed to extract one or more of the following: the job title, company, job location, job category, experience required, level of education, salary, company logo, graphic, etc. The parsing can be implemented in a number of ways. For example, the job listings can be pre-tagged with a mark up language, such as XML, to identify the contents of the job listing. In another embodiment, the relevant data from the job listing could be extracted using data entry personnel. In a further embodiment, the data can be extracted from the job listings using natural language processing software, such as the open source program Mallet (mallet.cs.umass.edu) to identify and categorize the relevant information.

The extracted listing terms are then used to determine the key terms 420d. The key terms represent the extracted and categorized portions of the job listings. For example, in the context of job listings key terms might include job title, company, logo, location, full-time/part-time, industry, category, experience, career level, education required, salary, a descriptive tag, and a full description. The key terms can then be used to create the generated ad 421. Since the detailed job listing is likely to have more key terms than can be reasonably inserted into the ad, only a subset of the key terms might be used in the ad. In one embodiment, for example, the decision of which key terms to use in the ad can be based upon templates implemented as ad generation rule sets. For example, the template might indicate that the job title is used as the title of the ad and company and salary are used as detail for the ad.

In the alternative, the key terms of the ad can be examined on an ad hoc basis to look for unique details or selling points that are used to choose which terms to use in the ad. This could be embodied by various rule based decisions programmed into the ad generation algorithm. One rule, for example, might check if the salary for the type of job listed is higher than average. If so, the system could choose to highlight the salary by referring to it the title of the ad. Another rule might check to determine if the job is in a desirable location. If so, this fact would be highlighted by the generated ad. A further rule might include a graphic or company logo in the ad if one is present in the job listing. A further rule could include a company logo if the company is above a certain size or is otherwise well known because candidates are more likely to apply for a job with a company they are familiar with.

Using either of the described techniques, or a combination of the techniques, one or more of the key terms are selected for the title 420e and inserted into the ad shell 421b. In addition, the details for the body of the ad 420f are also selected from one or more of the key terms, which are inserted into the ad shell 421c to create a final ad. In adding the title and details into the ad, the ad generation algorithm might add additional language to the inserted key term or the facts provided by the key term might be rewritten. For example, as shown in the FIG. 4B embodiment, the job listing term “Qualification—Two or more years of extensive experience” is rewritten as over 2 years of experience.

### Ad Optimization

FIG. 5 shows the generation of multiple ads from a single job listing 511 (based on full data entry 450 from FIG. 4A). Generating and distributing multiple ads can based on the same data entry optimizes ad effectiveness. To create multiple ads, the advertisement generator 520 chooses generation rule sets (different key terms for the title and ad detail) used to generate ads 521a-d. The generated ads 521a-d could be used to optimize the ad placement process by displaying the ads to multiple candidates to determine which of the ads are most effective. Or the ads could be targeted based upon information known about the site visitor to provide the most effective ad for the particular individual that will be viewing the ad.

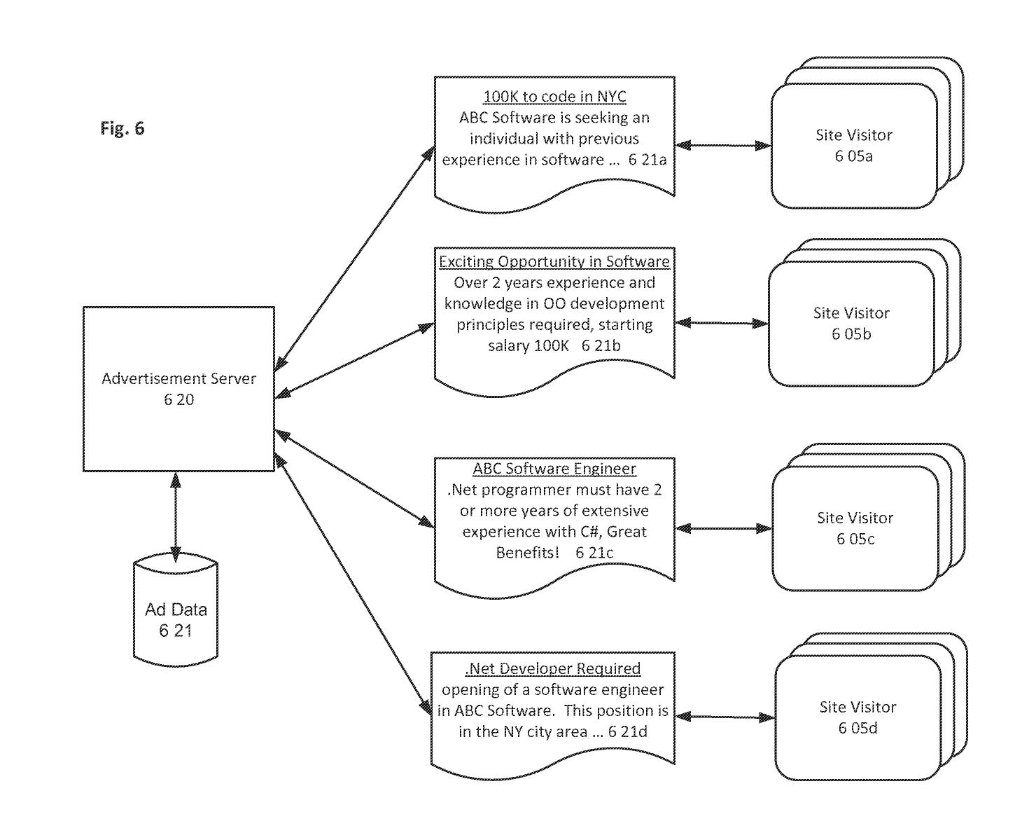

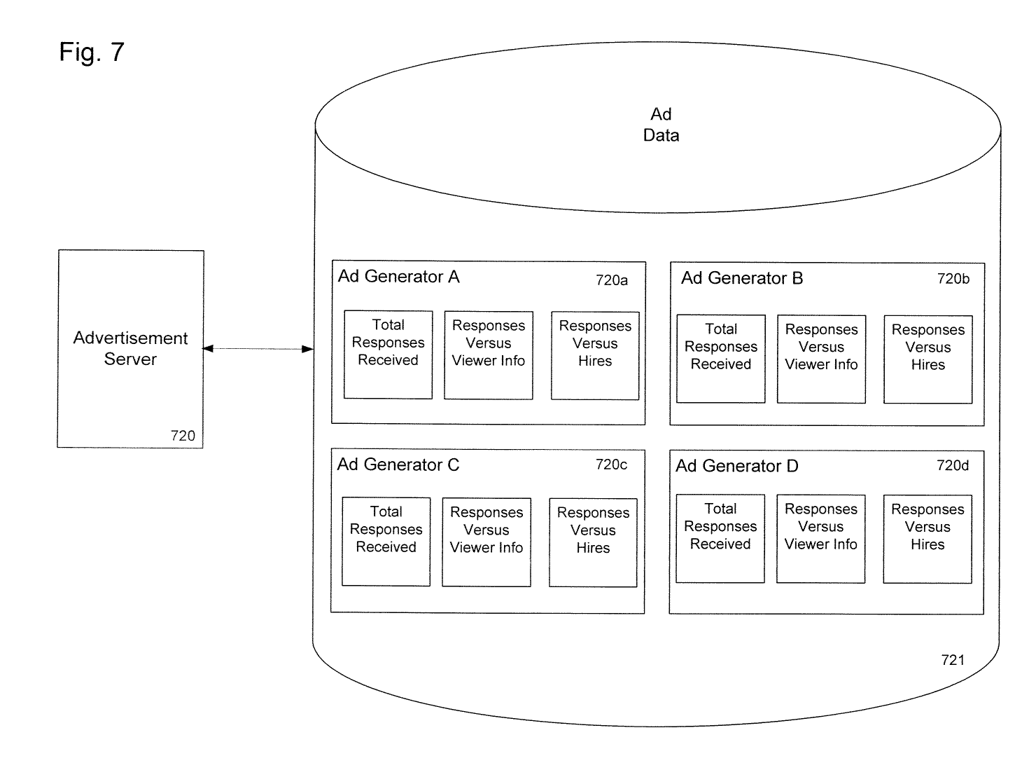

As shown in FIGS. 6-7, the effectiveness of each of the multiple generated ads can be determined by displaying the ads to various site visitors and recording their responses. The site visitors' reactions to the ads can be gauged in a number of ways. One basic measurement of ad success is click-throughs, i.e., the number of site visitors that click on the ad link for more information. An enhanced measurement of ad effectiveness is the number of site visitors that click on the ad and ultimately submit a job application. This metric is in some ways better than simple click-throughs because a submitted application demonstrates that the site visitor, not only found the ad compelling, but also found the underlying offer relevant enough to submit an application/resume. In contrast, a click-though metric may only indicate that the ad is broadly appealing, without identifying whether the ad is attracting relevant candidates. Another metric of ad effectiveness would track whether the candidates who submitted applications based on clicking through to the ad were ultimately hired. While this information would indicate that the ad brought in a suitable candidate, it may only be useful when there are a relatively large number of offers to be fulfilled. For example, if only one position needs to be filled, the hiring of a candidate ends the need for the ad.

As shown in FIG. 6, to gather the ad effectiveness data the advertisement server displays each of the ads 621a-d to groups of site visitors 605a-d, either directly or indirectly via an affiliate content server. Data about the effectiveness of each of the ads, e.g., click-throughs or applications submitted, is communicated back to the advertisement server. This information is associated with its respective ad and stored in an ad data store. For example, if one of the site visitors 605a responds positively to ad 621a, that fact is recorded in the ad data store. Additionally, meta-data about the site visitor 605a, such as their location, education level, etc., may also be associated with the record indicating ad success. This information can then be used to determine whether the particular ad is effective at reaching a target audience.

### Ad Evolution

An alternative to judging the effectiveness of particular ads, would be to judge the effectiveness of the various ad generation techniques used to create the ads. Determining the effectiveness of the ad generator has the advantage of being applicable beyond the limited case of a specific ad. For example, determining that a particular ad generation technique or algorithm is effective allows that ad generator to be used to produce additional effective ads for other listings. A further advantage could be had by associating the ad generator effectiveness with characteristics of the job listing for which the ad is created or with characteristics regarding the site visitors who responded to the ad. For example, measuring ad effectiveness might demonstrate that certain types of candidates value high pay over a flexible work schedule or visa versa. An employer, or the system, could then choose the ad generator that will best attract the most relevant candidates. That ad generator would be used to generate the ad.

FIG. 7 shows an embodiment for optimizing the effectiveness of particular ad generators. As shown in the figure, ad server 720 communicates with the ad data store 721 to record the effectiveness of various ad generators 720a-d, rather than the ads themselves. The ad generators 720a-d might represent any of the various ad generation techniques discussed above. For example, each of the ad generators may be a different ad generation template that is applied to the listing to generate the ad. Or, the ad generators may be rule based software algorithms that make ad hoc determinations based on the key terms extracted from the job listing.

Similar to the ad optimization discussed above, information recorded about the effectiveness of the ad generators might include, the total responses received by its generated ads, which could be measured as click-throughs. The responses may also, or alternatively, be recorded with associated data about the responding site visitor, which would enable the system to use ads/ad generators targeted to the site viewer in questions or targeted to the desired candidates. The quality of the ad generator can also be measured by the number of candidates successfully hired after responding to its generated ads. In the context of ad generators, this information is particularly valuable because successful ad generators can be used to produce ads for other employers based on their listings. The ad optimization data recorded might also include details about the job in question, which could then be used to identify whether particular generators work better for certain jobs. For example, a particular ad generator might work better at writing ads compelling to sales people, while another ad generator might write ads compelling to researcher scientists.

### Ad Targeting/Distribution

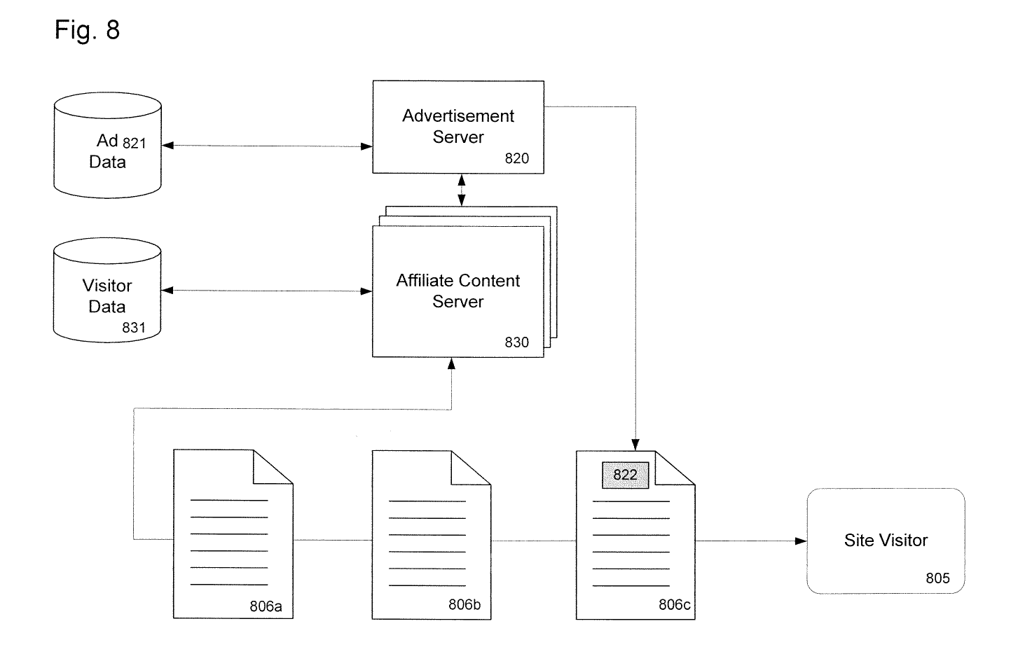

FIG. 8 shows the an embodiment for the placement of ads through the interaction of the advertisement server 820 and an affiliate content server 830. In this embodiment, one or more affiliate content servers 830 request ad serving from the advertisement server 820. The request may include stored or categorical information about the site visitor 805 from the visitor data store 831. The information about the site visitor 805 could have come from a number of sources. For example, the site visitor information could have been derived during the current web content session/interaction between the affiliate content server and the site visitor, such as information derived from the site visitors viewing and interaction with affiliate content pages 806a and 806b. Or, it could come from information received and stored during the site visitor's previous interactions with the affiliate content server. In addition, two or more different affiliate content servers might share or combine their saved site visitor data. Site visitor data might also have been previously stored by the advertisement server. For example, the site visitor data might be associated with a site visitor identifier, e.g., a cookie, the advertisement server might keep data indicating visitor characteristics associated with the identifier. In this way, the advertisement server can correlate information about the site visitor that was previously provided by one or more affiliate content servers and the advertisement server can track which ads were of interest to the site visitor. For example, if the site visitor had previously clicked on ads for java programmers, the advertisement server will have a highly relevant data point to indicate that programming jobs are of interest to that visitor.

In one embodiment, the site visitor's use of the affiliate content server service results in information about the site visitor being provided to the affiliate content server. For example, the affiliate content server may provided personality tests, skills evaluations, I.Q. tests, career recommendations, etc., such as the tests provided at tickle.com. When the site visitor uses the affiliate content server, information about himself or herself is gathered. In another example, the site visitor may have filled out a user profile that provides detailed information about him or herself. In another example, the affiliate content server may provide social or business networking services, such as myspace.com or linkedin.com. In using such a service, the site visitor may create a web page providing details about the users skills and interests. In another example, the affiliate content server may provide career services like monster.com. In using the service the site visitor may have uploaded a resume or created a user profile that indicates the user's skill set, educational background, work experience, interests, etc. In this way, it can be seen that the affiliate content server and the listings server may be one in the same entity.

Regardless of the mechanism in which information about the site visitor is recorded. Some or all of the recorded information is provided by the affiliate content server 830 to the advertisement server 820. In addition, information about the site visitor might be added based on context of the affiliate content site or added by categorizing the affiliate content site itself. In other words, a particular affiliate content site might indicate for itself that particular characteristics apply to all of its site visitors, or this determination may be made by the operators of the advertisement server. For example, an affiliate content site directed to semiconductor industry news might set forth that all of its site visitors are involved in the semiconductor industry. Or, the advertisement server might make that determination. In addition, the affiliate content server operator may want to have more control over the companies and types of ads that are displayed on its site and could set characteristics accordingly. For example, an affiliate content site devoted to alternative energy might want to exclude advertisements from oil companies.

Once the characteristics for a particular site visitor are received and gathered by the advertisement server, the advertisement server can use this information to retrieve an ad from the ad data store 821 and provide an advertisement that is narrowly targeted to suit the site visitor. The search for an ad targeted to the site visitor in question can be accomplished by database searches over the ad data store and associated matching algorithms. For example, if the affiliate content server provides the advertisement server with three facts about the site visitor, the advertisement server can search the ad data store for ads that most closely match the provided criteria. Any discovered ad 822 can then be inserted into content page 806c and presented to the site visitor by the affiliate content server 830. If multiple matching ads are discovered, multiple ads can be shown to the site visitor or the ads can be narrowed down based on additional criteria, such as the amount of revenue generated by the ad, the amount of time since the ad was last displayed, etc. The number of ads displayed to the site visitor may be determined by the number of ad positions made available by the affiliate content server. If the number of relevant ads matching the site visitor is less than the number of available ads, the extra ad space can be filled in with broad based ads or ads driving traffic for the system as a whole. For example, ads might drive traffic to the original listing service, e.g., the job listing server.

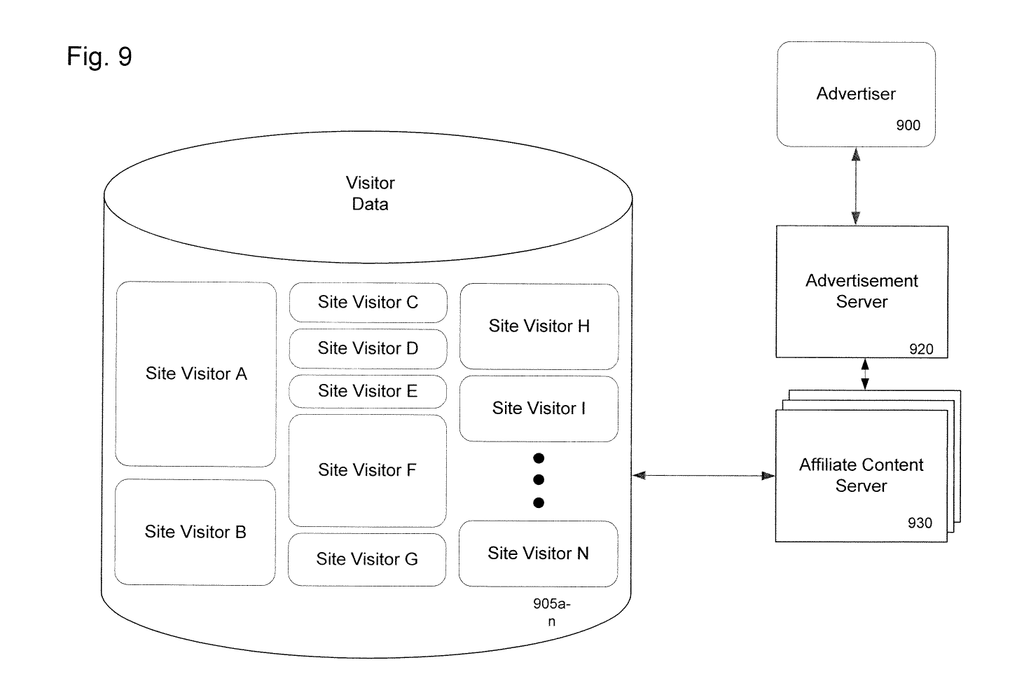

FIG. 9 shows an embodiment of the disclosed system through which the advertisers 900, e.g., employers with job listings, can have the placement of their ads tailored to the site visitors to which the ads will be presented based on site visitor characteristics. As shown in the figure, site visitor data 905a-n is stored by the affiliate content server 930. However, the amount of information known about the various site visitors is not uniform, as represented by the different sizes of the site visitor data files. So, for example. more information is known about site visitor 905a than is known about site visitor 905f.

With this collection of information, an advertiser can choose to only display ads to site visitors with a certain level of known details or with specific known details. For example, an advertiser might only want his ads shown to people working in information technology and living in or around New York City, or only to known college graduates. The advertisement server can also price the ads based upon the level of details known about the site visitor. For example, an advertiser might buy fewer, more expensive, narrowly targeted ads. Or, the advertiser could buy a larger number of cheaper less targeted ads.

In an alternative addition to the embodiment, the affiliate content provider might choose the amount of site visitor information they would like to provide to the advertisement server. In this way, if a site provider is sensitive about releasing particular information or certain amount of information, it can choose to release less than all of its information to the advertisement server.

Another aspect of the disclosed invention is that the compensation provided to the affiliate content server can be determined based upon the amount of information about the site visitor provided. In this way, affiliate content providers can be rewarded by providing more information, which will result in more effective ad choice and placement. If an affiliate content provider would like to provide reduced information about their site visitors, they can receive broader less profitable ads.

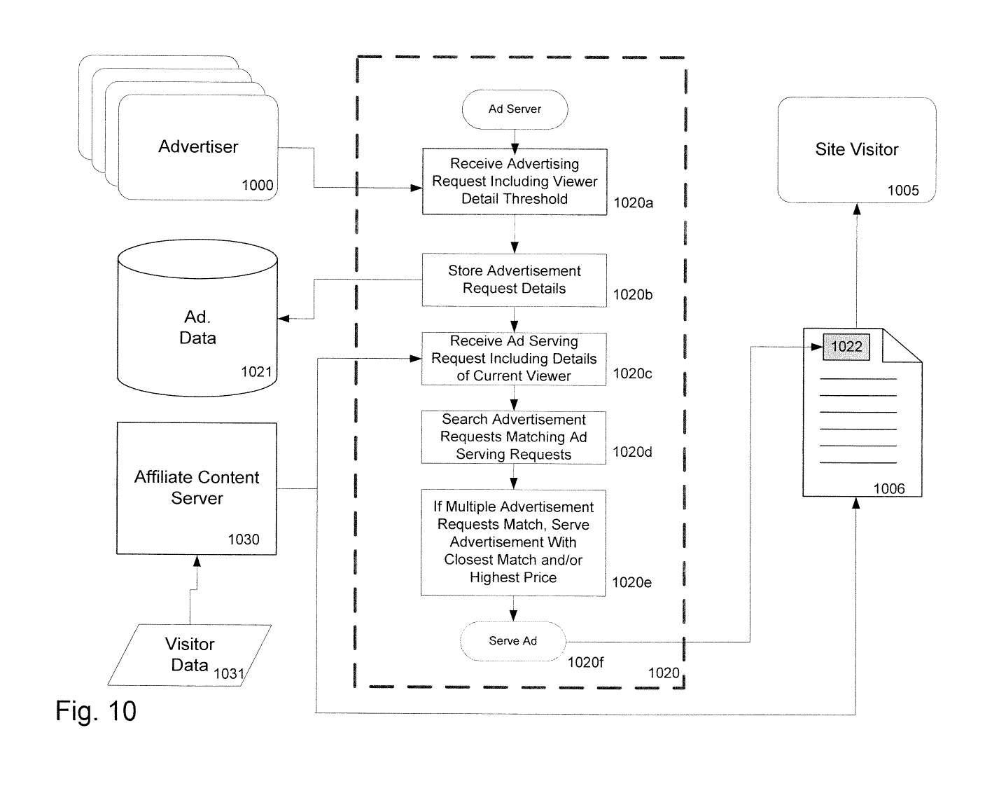

FIG. 10 shows an exemplary process and flow diagram for ad serving in accordance with the disclosed system. One or more advertisers 1000 submit a request for advertising, which is received by the ad server 1020a. Along with the request, the advertiser may include information indicating the site visitor criteria identifying preferred candidates for the advertisement and the amount the advertiser is willing to pay. In the alternative, the relevant site visitor criteria can be extracted from the content of the listing. The advertiser might also have specific requests. The advertiser, for example, may require that the ad is only shown to site visitors in a particular geographical region or with a specific education level. Or, the advertiser might simply indicate that its ads should only be displayed to site visitors that match a certain number of its listing criteria. For example, the advertiser might choose a level where the ad is only shown to site visitors that match three or more criteria relevant to its offer. The ad server can then store the advertisement request details 1020b in the ad data store 1021.

An affiliate content server 1030 will interact with the ad server to request ads to be displayed in the affiliate content server's content pages 1006. The affiliate content server 1030 will display its content to site visitor 1005. In interacting with the site visitor, or through previous interactions with the site visitor, the system develops site visitor data 1031. The site visitor data 1031 may be passed to the ad server along with the request for ad serving. Upon receipt of the ad serving request 1020c, the ad server searches 1020d the ad data 1021 for ads matching the request, including any supplied visitor data. If multiple potentially matching ads are discovered in the search, the ads with the highest price and/or the closest match to the submitted data are served 1020e. If only one ad is discovered, that ad is served. The ad to be served 1021 is inserted into the affiliated content server's content page 1006. This can be done directly by the ad server 1020 or the ad could be provided to the affiliate content server or insertion into the content.

In an alternative embodiment, instead of using pre-generated ads stored in the ad data store, the advertisement server may directly search the job listings data store for relevant job listings. If a job listing matching the ad request is discovered, an ad can be automatically generated using the ad generation techniques described above. The ad can then be inserted into the content displayed to the site visitor. In such system the ad data store could either be eliminated or it could be used to store details regarding the advertisers' requests, budgets, criteria, and ad pricing.

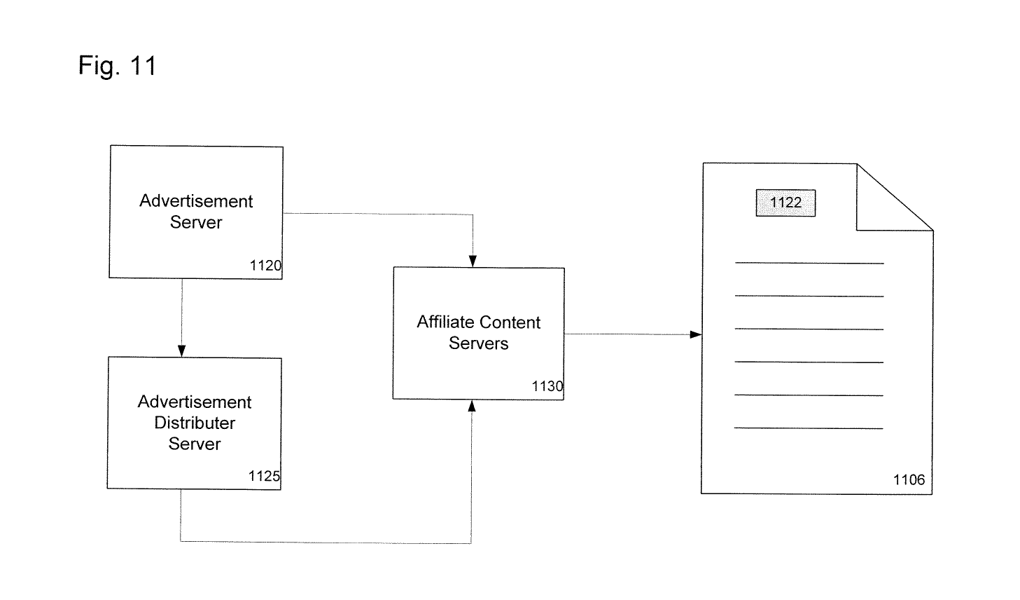

FIG. 11 shows an embodiment disclosing advertisement distribution in accordance with another aspect of the disclosed system. As shown in the figure, advertisement server 1120 is in communication with affiliate content servers 1130 and advertisement distribution server 1125. The affiliate content server displays site content pages 1106. The figure demonstrates a number of methods for distributing ads 1122 to the affiliate content server. In one embodiment the advertisement is passed from the advertisement server directly to the affiliate content server. It should be noted that ad could either be delivered as the content of the ad itself or it can be delivered as a symbolic link to the ad content. In another embodiment the ads can be served by a dedicated advertisement distribution server, which might be embodied by an existing commercial ad distribution network. In this way, the advertisement server can take advantage of large commercial distribution networks and have access to affiliate content serves that would like to source their advertisements through such a provider.

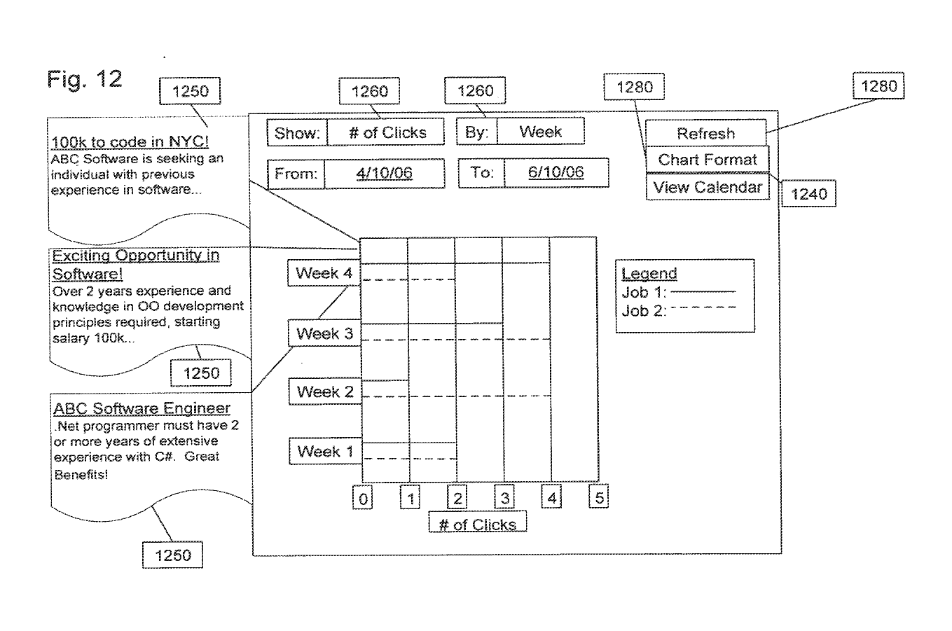

FIG. 12 illustrates aspects of the management dashboard according to another embodiment of the invention. In this implementation, the performance metrics are displayed directly next to generated advertisements 1250. As illustrated, a system user can manipulate a series of drop-down boxes 1260 in order to view a variety of performance metrics associated with the displayed advertisements 1250.

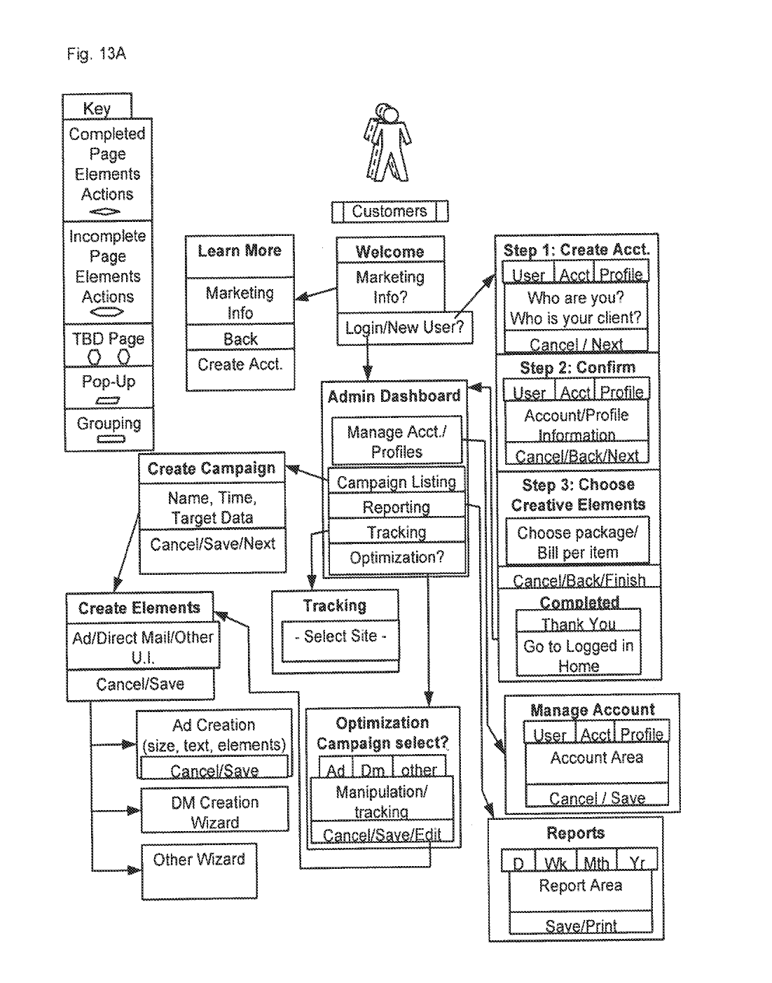

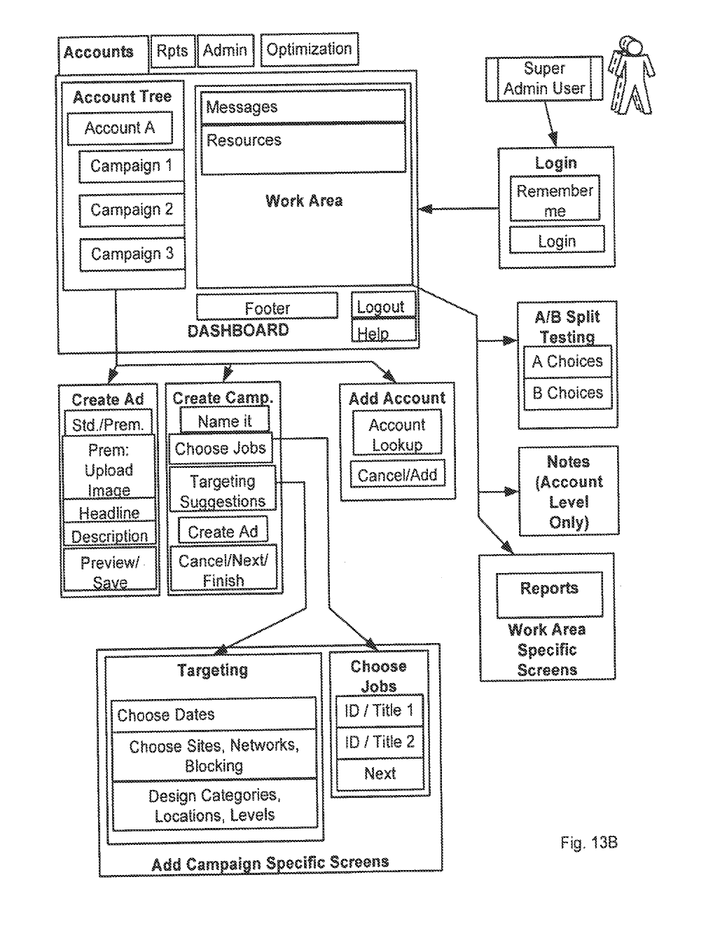

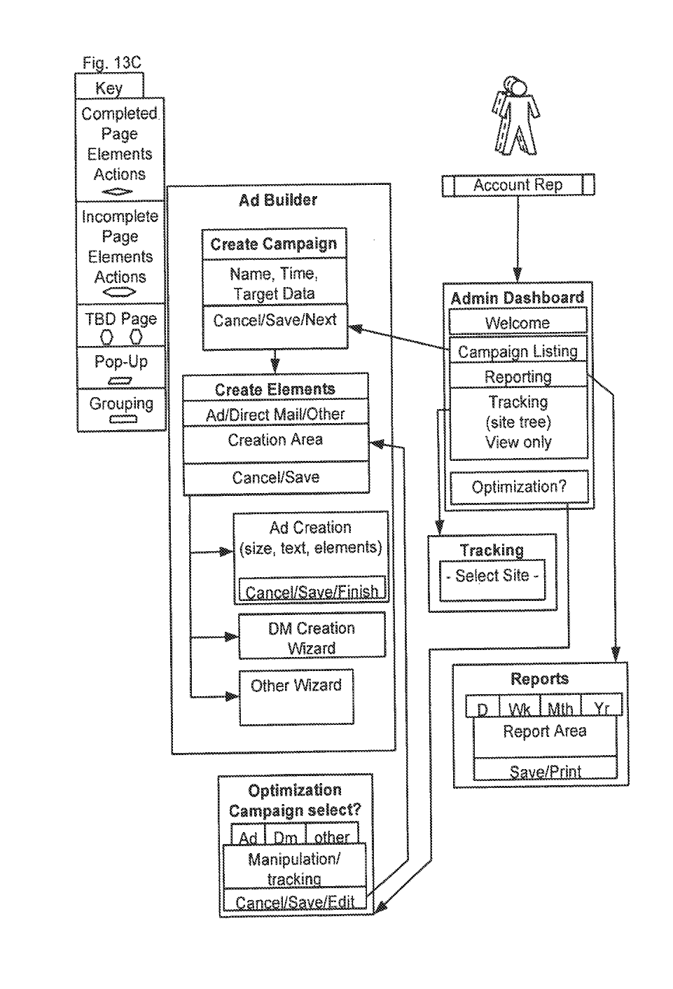

It is to be understood that the system is customizable based on the particular needs of a system user. FIGS. 13A-13C illustrate three different system configurations with functionality that customized for the particular user. The customer system configuration illustrated in FIG. 13A provides enough functionality so that the customer can interact with the system to establish generation/distribution/performance parameters or elect to implement the system default parameters. FIG. 13B illustrates an administrator's system configuration—enabling the administrator full access to all system components. In contrast, FIG. 13C illustrates an account representative system configuration with access to limited generation/distribution/performance metric functionality.

### Ad Generation And Serving Controller

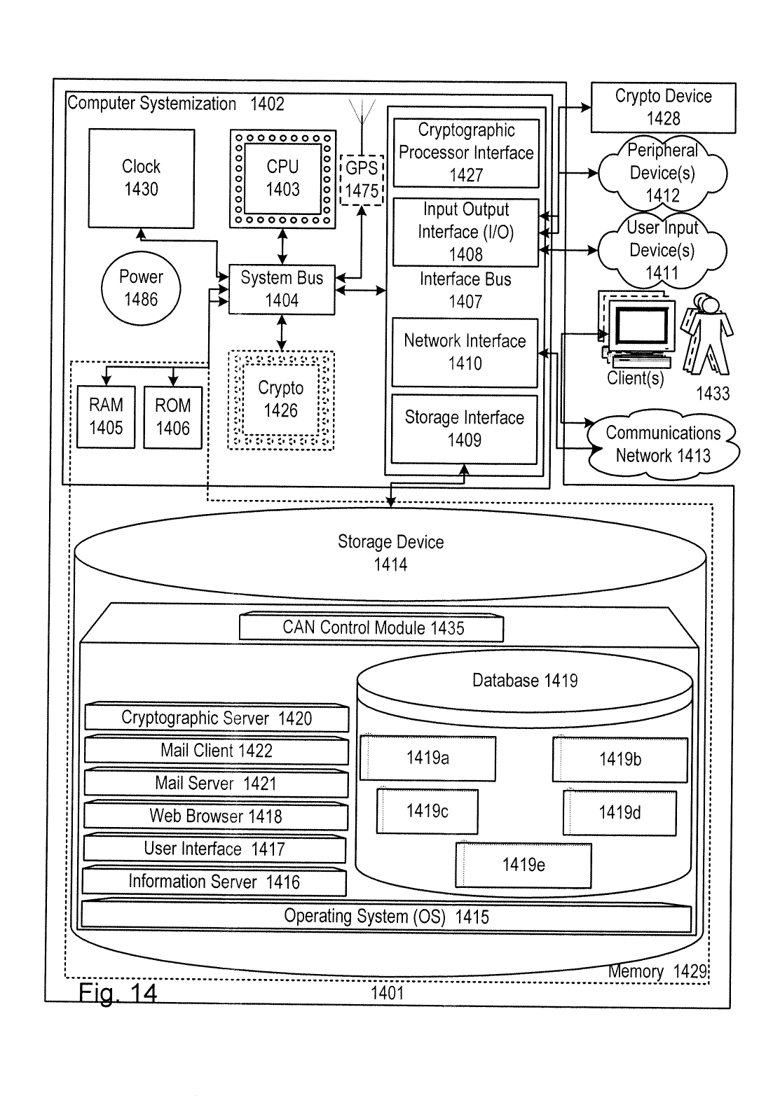

The advertisement server and generators described above can be embodied by an ad generation and serving (AGS) controller 1401. FIG. 14 of the present disclosure illustrates inventive aspects of the AGS controller 1401 in a block diagram. In this embodiment, the AGS controller 1401 may serve to generate, manage, price, sell, match, display, serve, and distribute advertisements.

Typically, users, which may be people and/or other systems, engage information technology systems (e.g., commonly computers) to facilitate information processing. In turn, computers employ processors to process information; such processors are often referred to as central processing units (CPU). A common form of processor is referred to as a microprocessor. A computer operating system, which, typically, is software executed by CPU on a computer, enables and facilitates users to access and operate computer information technology and resources. Common resources employed in information technology systems include: input and output mechanisms through which data may pass into and out of a computer; memory storage into which data may be saved; and processors by which information may be processed. Often information technology systems are used to collect data for later retrieval, analysis, and manipulation, commonly, which is facilitated through database software. Information technology systems provide interfaces that allow users to access and operate various system components.

In one embodiment, the AGS controller 1401 may be connected to and/or communicate with entities such as, but not limited to: one or ore users from user input devices 1411; peripheral devices 1411; and/or a communications network 1413.

Networks are commonly thought to comprise the interconnection and interoperation of clients, servers, and intermediary nodes in a graph topology. It should be noted that the term “server” as used throughout this disclosure refers generally to a computer, other device, software, or combination thereof that processes and responds to the requests of remote users across a communications network. Servers serve their information to requesting “clients.” The term “client” as used herein refers generally to a computer, other device, software, or combination thereof that is capable of processing and making requests and obtaining and processing any responses from servers across a communications network. A computer, other device, software, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The AGS controller 1401 may be based on common computer systems that may comprise, but are not limited to, components such as: a computer systemization 1402 connected to memory 1429.

### Computer Systemization

A computer systemization 1402 may comprise a clock 1430, central processing unit (CPU) 1403, a read only memory (ROM) 1406, a random access memory (RAM) 1405, and/or an interface bus 1407, and most frequently, although not necessarily, are all interconnected and/or communicating through a system bus 1404. Optionally, the computer systemization may be connected to an internal power source 1486. Optionally, a cryptographic processor 1426 may be connected to the system bus. The system clock typically has a crystal oscillator and provides a base signal. The clock is typically coupled to the system bus and various clock multipliers that will increase or decrease the base operating frequency for other components interconnected in the computer systemization. The clock and various components in a computer systemization drive signals embodying information throughout the system. Such transmission and reception of signals embodying information throughout a computer systemization may be commonly referred to as communications. These communicative signals may further be transmitted, received, and the cause of return and/or reply signal communications beyond the instant computer systemization to: communications networks, input devices, other computer systemizations, peripheral devices, and/or the like. Of course, any of the above components may be connected directly to one another, connected to the CPU, and/or organized in numerous variations employed as exemplified by various computer systems.

The CPU comprises at least one high-speed data processor adequate to execute program modules for executing user and/or system-generated requests. The CPU may be a microprocessor such as AMD's Athlon, Duron and/or Opteron; IBM and/or Motorola's PowerPC; Intel's Celeron, Itanium, Pentium, Xeon, Core and/or XScale; and/or the like processor(s). The CPU interacts with memory through signal passing through conductive conduits to execute stored program code according to conventional data processing techniques. Such signal passing facilitates communication within the AGS controller and beyond through various interfaces. Should processing requirements dictate a greater amount speed, parallel, mainframe and/or super-computer architectures may similarly be employed. Alternatively, should deployment requirements dictate greater portability, smaller Personal Digital Assistants (PDAs) may be employed.

### Power Source

The power source 1486 may be of any standard form for powering small electronic circuit board devices such as the following power cells: alkaline, lithium hydride, lithium ion, nickel cadmium, solar cells, and/or the like. Other types of AC or DC power sources may be used as well. In the case of solar cells, in one embodiment, the case provides an aperture through which the solar cell may capture photonic energy. The power cell 1486 is connected to at least one of the interconnected subsequent components of the AGS controller thereby providing an electric current to all subsequent components. In one example, the power source 1486 is connected to the system bus component 1404. In an alternative embodiment, an outside power source 1486 is provided through a connection across the I/O 1408 interface. For example, a USB and/or IEEE 1394 connection carries both data and power across the connection and is therefore a suitable source of power.

### Interface Adapters

Interface bus(ses) 1407 may accept, connect, and/or communicate to a number of interface adapters, conventionally although not necessarily in the form of adapter cards, such as but not limited to: input output interfaces (I/O) 1408, storage interfaces 1409, network interfaces 1410, and/or the like. Optionally, cryptographic processor interfaces 1427 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 1409 may accept, communicate, and/or connect to a number of storage devices such as, but not limited to: storage devices 1410, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 1410 may accept, communicate, and/or connect to a communications network 1413. Through a communications network 1413, the AGS controller is accessible through remote clients 1433b (e.g., computers with web browsers) by users 1433a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 1410 may be used to engage with various communications network types 1413. For example, multiple network interfaces may be employed to allow for the communication over broadcast, multicast, and/or unicast networks.

Input Output interfaces (I/O) 1408 may accept, communicate, and/or connect to user input devices 1411, peripheral devices 1412, cryptographic processor devices 1428, and/or the like. I/O may employ connection protocols such as, but not limited to: Apple Desktop Bus (ADB); Apple Desktop Connector (ADC); audio: analog, digital, monaural, RCA, stereo, and/or the like; IEEE 1394a-b; infrared; joystick; keyboard; midi; optical; PC AT; PS/2; parallel; radio; serial; USB; video interface: BNC, coaxial, composite, digital, Digital Visual Interface (DVI), RCA, RF antennae, S-Video, VGA, and/or the like; wireless; and/or the like. A common output device is a television set, which accepts signals from a video interface. Also, a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Typically, the video interface provides the composited video information through a video connection interface that accepts a video display interface (e.g., an RCA composite video connector accepting an RCA composite video cable; a DVI connector accepting a DVI display cable, etc.).

User input devices 1411 may be card readers, dongles, finger print readers, gloves, graphics tablets, joysticks, keyboards, mouse (mice), remote controls, retina readers, trackballs, trackpads, and/or the like.

Peripheral devices 1412 may be connected and/or communicate to I/O and/or other facilities of the like such as network interfaces, storage interfaces, and/or the like. Peripheral devices may be audio devices, cameras, dongles (e.g., for copy protection, ensuring secure transactions with a digital signature, and/or the like), external processors (for added functionality), goggles, microphones, monitors, network interfaces, printers, scanners, storage devices, video devices, video sources, visors, and/or the like.

It should be noted that although user input devices and peripheral devices may be employed, the AGS controller may be embodied as an embedded, dedicated, and/or monitor-less (i.e., headless) device, wherein access would be provided over a network interface connection.

### Memory

Generally, any mechanization and/or embodiment allowing a processor to affect the storage and/or retrieval of information is regarded as memory 1429. However, memory is a fungible technology and resource, thus, any number of memory embodiments may be employed in lieu of or in concert with one another. It is to be understood that the AGS controller and/or a computer systemization may employ various forms of memory 1429. For example, a computer systemization may be configured wherein the functionality of on-chip CPU memory (e.g., registers), RAM, ROM, and any other storage devices are provided by a paper punch tape or paper punch card mechanism; of course such an embodiment would result in an extremely slow rate of operation. In a typical configuration, memory 1429 will include ROM 1406, RAM 1405, and a storage device 1414. A storage device 1414 may be any conventional computer system storage. Storage devices may include a drum; a (fixed and/or removable) magnetic disk drive; a magneto-optical drive; an optical drive (i.e., CD ROM/RAM/Recordable (R), ReWritable (RW), DVD R/RW, etc.); and/or other devices of the like. Thus, a computer systemization generally requires and makes use of memory.

### Module Collection

The memory 1429 may contain a collection of program and/or database modules and/or data such as, but not limited to: operating system module(s) 1415 (operating system); information server module(s) 1416 (information server); user interface module(s) 1417 (user interface); Web browser module(s) 1418 (Web browser); database(s) 1419: cryptographic server module(s) 1420 (cryptographic server); the AGS module(s) 1435, which may include ad generators, ad servers, ad matching, ad storing, etc.; and/or the like (i.e., collectively a module collection). These modules may be stored and accessed from the storage devices and/or from storage devices accessible through an interface bus. Although non-conventional software modules such as those in the module collection, typically, are stored in a local storage device 1414, they may also be loaded and/or stored in memory such as: peripheral devices, RAM, remote storage facilities through a communications network, ROM, various forms of memory, and/or the like.

### Operating System

The operating system module 1415 is executable program code facilitating the operation of the AGS controller. Typically, the operating system facilitates access of I/O, network interfaces, peripheral devices, storage devices, and/or the like. The operating system may be a highly fault tolerant, scalable, and secure system such as Apple Macintosh OS X (Server), AT&T Plan 9, Be OS, Linux, Unix, and/or the like operating systems. However, more limited and/or less secure operating systems also may be employed such as Apple Macintosh OS, Microsoft DOS, Palm OS, Windows 2000/2003/3.1/95/98/CE/Millenium/NT/XP (Server), and/or the like. An operating system may communicate to and/or with other modules in a module collection, including itself, and/or the like. Most frequently, the operating system communicates with other program modules, user interfaces, and/or the like. For example, the operating system may contain, communicate, generate, obtain, and/or provide program module, system, user, and/or data communications, requests, and/or responses. The operating system, once executed by the CPU, may enable the interaction with communications networks, data, I/O, peripheral devices, program modules, memory, user input devices, and/or the like. The operating system may provide communications protocols that allow the AGS controller to communicate with other entities through a communications network 413. Various communication protocols may be used by the AGS controller as a subcarrier transport mechanism for interaction, such as, but not limited to: multicast, TCP/IP, UDP, unicast, and/or the like.

### Information Server

An information server module 1416 is stored program code that is executed by the CPU. The information server may be a conventional Internet information server such as, but not limited to Apache Software Foundation's Apache, Microsoft's Internet Information Server, and/or the. The information server may allow for the execution of program modules through facilities such as Active Server Page (ASP), ActiveX, (ANSI) (Objective-) C(++), C#, Common Gateway Interface (CGI) scripts, Java, JavaScript, Practical Extraction Report Language (PERL), Python, WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), and/or the like. The information server provides results in the form of Web pages to Web browsers, and allows for the manipulated generation of the Web pages through interaction with other program modules. After a Domain Name System (DNS) resolution portion of an HTTP request is resolved to a particular information server, the information server resolves requests for information at specified locations on the AGS controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other modules in a module collection, including itself, and/or facilities of the like. Most frequently, the information server communicates with the AGS controller, operating systems, other program modules, user interfaces, Web browsers, and/or the like.

Also, an information server may contain, communicate, generate, obtain, and/or provide program module, system, user, and/or data communications, requests, and/or responses.

### User Interface

The function of computer interfaces in some respects is similar to automobile operation interfaces. Automobile operation interface elements such as steering wheels, gearshifts, and speedometers facilitate the access, operation, and display of automobile resources, functionality, and status. Computer interaction interface elements such as check boxes, cursors, menus, strollers, and windows (collectively and commonly referred to as widgets) similarly facilitate the access, operation, and display of data and computer hardware and operating system resources, functionality, and status. Operation interfaces are commonly called user interfaces. Graphical user interfaces (GUIs) such as the Apple Macintosh Operating System's Aqua, Microsoft's Windows XP, or Unix's X-Windows provide a baseline and means of accessing and displaying information graphically to users.

A user interface module 1417 is stored program code that is executed by the CPU. The user interface may be a conventional graphic user interface as provided by, with, and/or atop operating systems and/or operating environments such as Apple Macintosh OS, e.g., Aqua, Microsoft Windows (NT/XP), Unix X Windows (KDE, Gnome, and/or the like), mythTV, and/or the like. The user interface may allow for the display, execution, interaction, manipulation, and/or operation of program modules and/or system facilities through textual and/or graphical facilities. The user interface provides a facility through which users may affect, interact, and/or operate a computer system. A user interface may communicate to and/or with other modules in a module collection, including itself, and/or facilities of the like. Most frequently, the user interface communicates with operating systems, other program modules, and/or the like. The user interface may contain, communicate, generate, obtain, and/or provide program module, system, user, and/or data communications, requests, and/or responses.

### Web Browser

A Web browser module 1418 is stored program code that is executed by the CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Some Web browsers allow for the execution of program modules through facilities such as Java, JavaScript, ActiveX, and/or the like. Web browsers and like information access tools may be integrated into PDAs, cellular telephones, and/or other mobile devices. A Web browser may communicate to and/or with other modules in a module collection, including itself, and/or facilities of the like. Most frequently, the Web browser communicates with information servers, operating systems, integrated program modules (e.g., plug-ins), and/or the like; e.g., it may contain, communicate, generate, obtain, and/or provide program module, system, user, and/or data communications, requests, and/or responses. Of course, in place of a Web browser and information server, a combined application may be developed to perform similar functions of both. The combined application would similarly affect the obtaining and the provision of information to users, user agents, and/or the like from the AGS controller enabled nodes. The combined application may be nugatory on systems employing standard Web browsers.

### AGS Controller Module

The AGS controller module 1435 is stored program code that is executed by the CPU. The AGS controller module affects accessing, generating, managing, selling, displaying, hosting, serving, distributing matching, and storing of advertisments, and/or the like across various communications networks.

The AGS controller module enabling access of information between nodes may be developed by employing standard development tools such as, but not limited to: (ANSI) (Objective-) C(++), Apache modules, binary executables, database adapters, Java, JavaScript, mapping tools, procedural and object oriented development tools, PERL, Python, shell scripts, SQL commands, web application server extensions, WebObjects, and/or the like. The AGS controller module may communicate to and/or with other modules in a module collection, including itself, and/or facilities of the like. Most frequently, the AGS controller module communicates with the a job listing servers, affiliate content servers, ad data stores, operating systems, other program modules, and/or the like. The AGS controller module may contain, communicate, generate, obtain, and/or provide program module, system, user, and/or data communications, requests, and/or responses.

### Distributed the AGS Controller Module

The structure and/or operation of any of the AGS controller components may be combined, consolidated, and/or distributed in any number of ways to facilitate development and/or deployment. Similarly, the module collection may be combined in any number of ways to facilitate deployment and/or development. To accomplish this, one may integrate the components into a common code base or in a facility that can dynamically load the components on demand in an integrated fashion.

The module collection may be consolidated and/or distributed in countless variations through standard data processing and/or development techniques. Multiple instances of any one of the program modules in the program module collection may be instantiated on a single node, and/or across numerous nodes to improve performance through load-balancing and/or data-processing techniques. Furthermore, single instances may also be distributed across multiple controllers and/or storage devices; e.g., databases. All program module instances and controllers working in concert may do so through standard data processing communication techniques.

The configuration of the AGS controller will depend on the context of system deployment. Factors such as, but not limited to, the budget, capacity, location, and/or use of the underlying hardware resources may affect deployment requirements and configuration. Regardless of if the configuration results in more consolidated and/or integrated program modules, results in a more distributed series of program modules, and/or results in some combination between a consolidated and distributed configuration, data may be communicated, obtained, and/or provided. Instances of modules consolidated into a common code base from the program module collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If module collection components are discrete, separate, and/or external to one another, then communicating, obtaining, and/or providing data with and/or to other module components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), process pipes, shared files, and/or the like. Messages sent between discrete module components for inter-application communication or within memory spaces of a singular module for intra-application communication may be facilitated through the creation and parsing of a grammar. A grammar may be developed by using standard development tools such as lex, yacc, XML, and/or the like, which allow for grammar generation and parsing functionality, which in turn may form the basis of communication messages within and between modules. Again, the configuration will depend upon the context of system deployment.

The entirety of this disclosure (including the Cover Page, Title, Headings, Field, Background, Summary, Brief Description of the Drawings, Detailed Description, Claims, Abstract, Figures, and otherwise) shows by way of illustration various embodiments in which the claimed inventions may be practiced. The advantages and features of the disclosure are of a representative sample of embodiments only, and are not exhaustive and/or exclusive. They are presented only to assist in understanding and teach the claimed principles. It should be understood that they are not representative of all claimed inventions. As such, certain aspects of the disclosure have not been discussed herein. That alternate embodiments may not have been presented for a specific portion of the invention or that further undescribed alternate embodiments may be available for a portion is not to be considered a disclaimer of those alternate embodiments. It will be appreciated that many of those undescribed embodiments incorporate the same principles of the invention and others are equivalent. Thus, it is to be understood that other embodiments may be utilized and functional, logical, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program modules (a module collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the invention, and inapplicable to others. In addition, the disclosure includes other inventions not presently claimed. Applicant reserves all rights in those presently unclaimed inventions including the right to claim such inventions, file additional applications, continuations, continuations in part, divisions, and/or the like thereof. As such, it should be understood that advantages, embodiments, examples, functional, features, logical, organizational, structural, topological, and/or other aspects of the disclosure are not to be considered limitations on the disclosure as defined by the claims or limitations on equivalents to the claims.

What is claimed is:

1. A processor-implemented method for advertisement management, comprising:
retrieving an opportunity structured listing and an advertisement template from a database;
parsing the opportunity structured listing to extract opportunity key terms based on the advertisement template;
generating an advertisement by populating the extracted opportunity key terms from the parsed opportunity structured listing into the retrieved advertisement template;
distributing the generated advertisement to a content provider for incorporation into displayed content;
obtaining web user characteristics associated with a web user identifier via a web user's viewing the content provider's displayed content;
correlating the advertisement with the obtained web user characteristics;
identifying a web user as a distribution target for the advertisement based on the correlation; and
distributing the advertisement to the web user and tracking web user interaction with the distributed advertisement.

2. The method as claimed in claim 1, further comprising the steps of:
receiving web user interaction data; and
processing the web user interaction data and deriving performance metrics for the distributed advertisement.

3. The method as claimed in claim 2 further comprising the processor aggregating the performance metrics for a campaign of distributed advertisements.

4. The method as claimed in claim 3 further comprising the processor maintaining a campaign management dashboard, and displaying the aggregate performance metrics associated with advertisements within the campaign.

5. The method as claimed in claim 3 further comprising the processor maintaining a campaign management desktop widget and displaying the aggregate performance metrics associated with advertisements within the campaign.

6. The method as claimed in claim 4 or claim 5 further comprising the step of displaying distribution or generation parameters associated with advertisements within the campaign.

7. The method as claimed in claim 1 and further comprising the steps of:
receiving an advertisement management request associated with a selected advertisement from a user interface;
obtaining web user interaction data indicating advertisement performance of the selected advertisement;
determining advertisement performance improvement indicia based on the obtained web user interactive activity data;
modifying a plurality of advertisement configuration parameters for the selected advertisement based on the determined advertisement performance improvement indicia, said plurality of advertisement configuration parameters including, any one or more of: an advertisement generation rule set, advertisement targeting parameters, advertisement distribution parameters, advertisement evolutionary generation parameters, and advertisement performance metrics rules;
updating the selected advertisement based on the modified advertisement generation rule set and advertisement evolutionary generation parameters; and
re-distributing the updated selected advertisement to a target user based on the modified advertisement targeting parameters and advertisement distribution parameters.

8. The method as claimed in claim 7, wherein the resulting performance metrics are used to populate a campaign management dashboard.

9. The method as claimed in claim 7, wherein the resulting performance metrics are used to populate a campaign management desktop widget.

10. A system for advertising management comprising:
a memory;
a processor disposed in communication with said memory, and configured to issue a plurality of processing instructions stored in the memory, wherein the instructions issue signals to:
retrieve an opportunity structured listing and an advertisement template from a database;
parse the opportunity structured listing to extract opportunity key terms based on the advertisement template;
generate an advertisement by populating the extracted opportunity key terms from the parsed opportunity structured listing into the retrieved advertisement template;
distribute the generated advertisement to a content provider for incorporation into displayed content;
obtain via a communication network web user characteristics associated with a web user identifier via a web user's viewing the content provider's displayed content;
correlating the advertisement with the obtained web user characteristics;
identifying a web user as a distribution target for the advertisement based on the correlation; and
distributing the advertisement to the web user and tracking web user interaction with the distributed advertisement.

11. The system as claimed in claim 10 further comprising instructions configured to:
receive web user interaction data; and
process the web user interaction data and derive performance metrics for the distributed advertisement.

12. The system as claimed in claim 11, wherein the system aggregates the performance metrics for a campaign of distributed advertisements.

13. The system as claimed in claim 12, wherein the system is further configured to maintain a campaign management dashboard and display the aggregate performance metrics associated with advertisements within the campaign.

14. The system as claimed in claim 12, wherein the system is further configured to maintain a campaign management desktop widget and display the aggregate performance metrics associated with advertisements within the campaign.

15. The system as claimed in claim 13 or claim 14 wherein the system is further configured to display distribution or generation parameters associated with advertisements within the campaign.

16. The system as claimed in claim 10, further comprising a user interface whereby the system is configures to receive an advertisement management request associated with a selected advertisement, and in response to receiving an advertisement management request the system is configured to:
obtain web user interaction data indicating advertisement performance of the selected advertisement;
determine advertisement performance improvement indicia based on the obtained web user interactive activity data;
modify a plurality of advertisement configuration parameters for the selected advertisement based on the determined advertisement performance improvement indicia, said plurality of advertisement configuration parameters including, any one or more of: an advertisement generation rule set, advertisement targeting parameters, advertisement distribution parameters, advertisement evolutionary generation parameters, and advertisement performance metrics rules;
update the selected advertisement based on the modified advertisement generation rule set and advertisement evolutionary generation parameters; and
re-distribute the updated selected advertisement to a target user based on the modified advertisement targeting parameters and advertisement distribution parameters.

17. The system as claimed in claim 16, wherein the resulting performance metrics are used to populate a campaign management dashboard.

18. The system as claimed in claim 16, wherein the resulting performance metrics are used to populate a campaign management desktop widget.

19. The system as claimed in claim 10 implemented as one or more modules each module configured to execute any one or more of: an advertising targeting process, an advertising distribution process, an advertisement evolutionary generation process, and an advertisement performance metrics process.
